(19) United States
(12) Patent Application Publication
(10) Pub. No.: US 2006/0120383 A1
(43) Pub. Date: Jun. 8, 2006

(54) Apparatus and method for compensating for PCR and data rate

(75) Inventors: Sang-Ho Kim, Hwaseong-si (KR); Jae-Hun Cho, Seoul (KR); Chang-Sup Shim, Seoul (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/296,618

(22) Filed: Dec. 7, 2005

(30) Foreign Application Priority Data
Dec. 8, 2004 (KR) 2004-103077

(51) Int. Cl. H04L 12/56; H04L 12/28

(52) U.S. Cl. 370/395.64; 370/412

(57) ABSTRACT

A method and apparatus by which a reception device of a communication system can sense and compensate for an error of a program clock reference (PCR), and can sense and compensate for bit rate variation of transmission data in a transmitted MPEG-2 TS. The method and apparatus compensates for a PCR jitter, or a change in a data bit rate, which may occur in processing an MPEG-2 TS in a reception device of the MPEG-2 TS transmission system, thereby preventing the deterioration of image quality due to the jitter or loss of an input MPEG-2 TS data. The apparatus includes a PAT sensing unit for sensing a PAT from a received MPEG-2 TS, a PMT sensing unit for sensing a PMT based on information provided from the PAT sensing unit, a PCR PID unit for sensing a PCR PID based on information provided from the PMT sensing unit and a PCR data unit for outputting a PCR data based on information provided from the PMT sensing unit and PID information provided from the PCR PID unit. The apparatus also includes a PCR comparison/compensation unit receiving the PCR data from the PCR data unit, comparing the received PCR data with a pre-stored PCR data, and compensating for the pre-stored PCR data, and a data rate comparison/compensation unit for receiving data rate information from the PCR data unit, comparing the received data rate with a pre-stored data rate, and compensating for the pre-stored data rate.

### CLAIM OF PRIORITY

This application claims the benefit under 35 U.S.C. 119(a) of an application entitled “Apparatus And Method For Compensating For PCR And Data Rate,” filed in the Korean Intellectual Property Office on Dec. 8, 2004 and assigned Serial No. 2004-103077, the entire contents of which are incorporated herein by reference.

### BACKGROUND OF THE INVENTION

1. Field of the Invention

The present invention relates to a Moving Picture Experts Group-2 transport stream (MPEG-2 TS) transmission system, and more particularly to a method by which a reception device can sense and compensate for an error of a program clock reference (PCR). The PRC serves as a temporal reference. If an error occurs, and the reception device can compensate for a bit rate variation of transmission data in a transmitted MPEG-2 TS.

2. Description of the Related Art

MPEG-2 (ISO/IEC 13818) is derived from MPEG-1, is an encoding scheme for a high-quality video to be transmitted through a computer network. The MPEG-2, has been employed in various fields, that include digital satellite broadcasting, a high-definition television, a digital video disk (DVD) and Video on Demand (VOD), owing to its excellent performance and flexibility. In this regard, MPEG-2 serves as a driving force leading a multimedia revolution. An MPET-2 transmission system combines an MPET-2 video bit stream and an MPET-2 audio bit stream to transmit or store them. For example, a video encoder produces an MPEG video data stream and the audio encoder produces an MPEG audio data stream. These streams are called ‘MPEG Elementary Streams’ (ES). Both audio and video ES data streams are divided in packets (for the video encoder, each packet is a picture frame). The resulting streams are called ‘MPEG Packetized Elementary Streams’ (PES).

The audio and video PES packets are fed to the Transport Stream Multiplexer. This module produces a Transport Stream (TS) which contains the audio and video PES streams, together with clock reference information. The audio, video and clock reference data of one encoder is referred to as a ‘Program’.

The clock reference information is used to recover the encoder clock at the decoder and guarantees that the decoder decodes audio and video at exactly the same rate as the encoder. If the decoder playback rate differs from the encoder rate, this will result in buffer over- or underflow at the decoder.

In particular, when the MPET-2 video bit stream and the MPET-2 audio bit stream are multiplexed into one bit stream, it is necessary for the transmitted bit stream to have a protocol or storage format adapted to a communication channel or storage media. In addition, providing a means for synchronization (lip sync) of video and audio is also one important function of the MPET-2 transmission system. This MPET-2 transmission system uses two kinds of multiplexing schemes. One is a program stream (PS) to multiplex a single program in a channel environment not having any error. The other is a transport stream (TS) to multiplex a plurality of programs in a channel environment having an error. The transport stream multiplexing a plurality of programs into one bit stream is suitable for digital television broadcasting in a multimedia age. It also has been designed to have a scramble function (which encodes a bit stream in order to allow only paid subscribers to view corresponding contents) to restrict reception. In addition, directory information or information about an individual bit stream can be carried in order to facilitate random access.

In particular, a Transport Stream consists of TS packets. Each TS packet contains a Header and a Payload section. The header of each packet contains information about the contents of that packet and is meant for the TS demultiplexer. The payload section contains the actual audio, video, teletext, etc. data. The header starts with a synchronisation word, used to recognize the start of the packet. Then two bytes follow which contain some flags and the Packet ID (PID).

This PID is very important. The PID is used to identify the contents of the packets. For example: a TS can contain a video PES in packets with PID 100, an audio PES in packets with PID 101 and clock reference information belonging to these streams in packets with PID 102. But it can also contain a second video PES in packets with PID 200.

Service Information is used to allow the decoder to know which PID's belong to which program. The service information is contained in a number of tables. These tables are transmitted as separate streams, like video and audio streams. Such service information may include, for example, PAT (program association table), PMT (program map table) and TOT (time offset table).

The MPET-2 transmission system employs a packet multiplexing arrangement that has been used in a time division multiplexing (TDM) scheme. Each video and audio bit streams is first divided into packetized elementary streams (PESs), which are called packets, having a predetermined length. Each divided PES packet has a limited maximum length of 64 KB to correspond to various applications, and may have either a fixed length or a variable length. Also, each PES packet may be transmitted either at a variable transmission rate or intermittently. The program stream and the transport stream are made by multiplexing each PES into one bit stream. In this case, the length of a packet depends upon the transmission channel and the medium.

Since this MPET-2 transmission system employs the TDM scheme, it is important to synchronize time between a transmission apparatus and a reception device. To this end, in the MPET-2 transmission system, an encoder of the transmission apparatus and a decoder of the reception device use a system clock of 27 MHz to synchronize the two apparatuses. This synchronizes the video stream and an audio stream, and controls the extraction of frames so that an overflow or underflow in a buffer of the decoder does not occur.

In order to maintain a synchronization state between the encoder and the decoder, the encoder periodically adds a PCR to a TS. The decoder having received the TS including the PCR then controls the system clock using the received PCR whenever the need arises.

FIG. 1 is a block diagram illustrating a structure for processing a data bit rate which suddenly changes in a reception device of the conventional MPET-2 transmission system.

The reception device of the conventional MPET-2 transmission system includes an MPET-2 TS processing unit 100, which receives an MPET-2 TS and outputs a broadcast signal. The MPET-2 TS processing unit 100 includes an input buffer 101 for processing the MPET-2 TS.

In such a reception device, it is difficult to adaptively deal with a change of a bit rate or PCR of an input MPET-2 TS. In this regard, even when a bit rate of an input MPET-2 TS increases only slightly, an error may occur, or data may be lost.

FIG. 2 is a block diagram illustrating the case of using a mass-storage buffer 201 as an input buffer in order to compensate for the above-mentioned problem.

In this case, since data is processed after the mass-storage buffer 201 is filled with the data, a time delay occurs in processing an input MPET-2 TS, so that it is not possible to process data in real time.

### SUMMARY OF THE INVENTION

One aspect of the present invention relates to an apparatus and method for compensating for a PCR jitter, or a change in a data bit rate, which may occur in processing an MPET-2 TS in a reception device of an MPET-2 TS transmission system. This prevents deterioration of image quality due to the jitter or loss of an input MPET-2 TS data.

One embodiment of the present invention is directed to an apparatus for compensating for a program clock reference (PCR) and a data bit rate in a reception device for a moving picture experts group-2 transport stream (MPET-2 TS) transmission system. The apparatus includes a PAT (Program Association Table) sensing unit for sensing a PAT from a received MPET-2 TS, a PMT (Program Map Table) sensing unit for sensing a PMT based on information provided from the PAT sensing unit, a PCR PID (Packet ID) unit for sensing a PCR PID based on information provided from the PMT sensing unit and a PCR data unit for outputting a PCR data based on information provided from the PMT sensing unit and PID information provided from the PCR PID unit. The apparatus also includes a PCR comparison/compensation unit receiving the PCR data from the PCR data unit, comparing the received PCR data with a pre-stored PCR data, and compensating for the pre-stored PCR data; and a data rate comparison/compensation unit for receiving data rate information from the PCR data unit, comparing the received data rate with a pre-stored data rate, and compensating for the pre-stored data rate.

Another embodiment of the present invention is directed to a method for compensating for a program clock reference (PCR) in a reception device for a moving picture experts group-2 transport stream (MPET-2 TS) transmission system. The method includes the steps of sensing a PAT from a received MPET-2 TS, sensing a PMT by using sensed PAT information, sensing a PCR PID by using sensed PMT information and outputting a PCR data according to the sensed PMT information and PCR PID information and the method also includes the steps of receiving and comparing the PCR data with a pre-stored PCR data, and compensating for the pre-stored PCR data based on a result of the comparison.

Yet another embodiment of the present invention is directed to a method for compensating for a data rate in a reception device for a moving picture experts group-2 transport stream (MPET-2 TS) transmission system. The method includes the steps of sensing a PAT from a received MPET-2 TS, sensing a PMT by using sensed PAT information, sensing a PCR PID by using sensed PMT information, outputting a data rate according to the sensed PMT information and PCR PID information and receiving and comparing the data rate with a pre-stored data rate, and compensating for the pre-stored data rate based on a result of the comparison result.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a block diagram illustrating a structure for processing a data bit rate which suddenly changes in a reception device of the conventional MPET-2 transmission system;

FIG. 2 is a block diagram illustrating another structure for processing a data bit rate which suddenly changes in a reception device of the conventional MPET-2 transmission system;

FIG. 3 is a block diagram illustrating the structure of a PCR and data bit rate compensation apparatus provided in a reception device of an MPET-2 TS transmission system according to an embodiment of the present invention;

FIG. 4 is a flowchart illustrating the procedure for compensating for PCR information in a PCR and data bit rate compensation apparatus provided in a reception device of an MPET-2 TS transmission system according to an embodiment of the present invention; and

FIG. 5 is a flowchart illustrating a procedure for compensating for a data rate in the PCR and data bit rate compensation apparatus provided in the reception device of an MPET-2 TS transmission system according to an embodiment of the present invention.

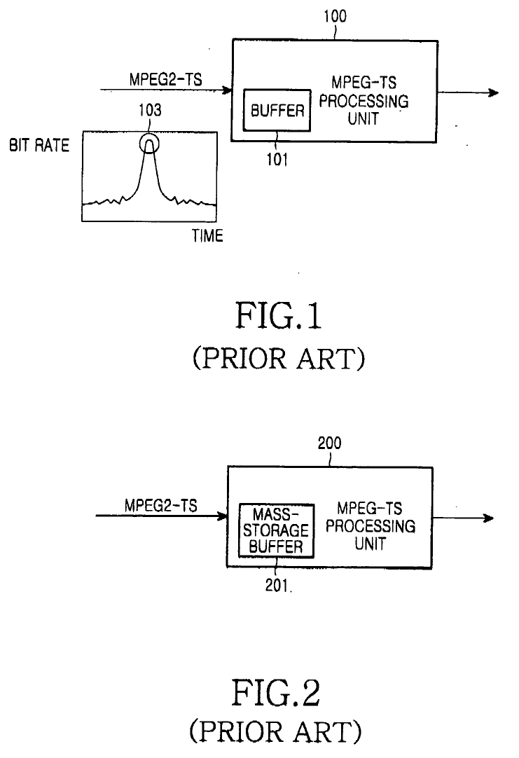

### DETAILED DESCRIPTION

Hereinafter, embodiments of the present invention will be described with reference to the accompanying drawings. It is to be noted that the same elements are indicated with the same reference numerals throughout the drawings. For the purposes of clarity and simplicity, a detailed description of known functions and configurations incorporated herein will be omitted when it may obscure the subject matter of the present invention.

With the advancement of technology, demand for a high-quality video service with ensured quality of service (QoS) has increased. Especially, the digitalization of broadcasting accelerates this phenomenon. To this end, MPET-2 is used as an encoding format to provide a high-quality video service.

In following description, embodiments of present invention will be explained based on the reception device of an MPET-2 TS transmission system. In this case, a transmission device of the MPET-2 TS transmission system is equal to the transmission device of the existing MPET-2 TS transmission system, so a detailed description thereof will be omitted.

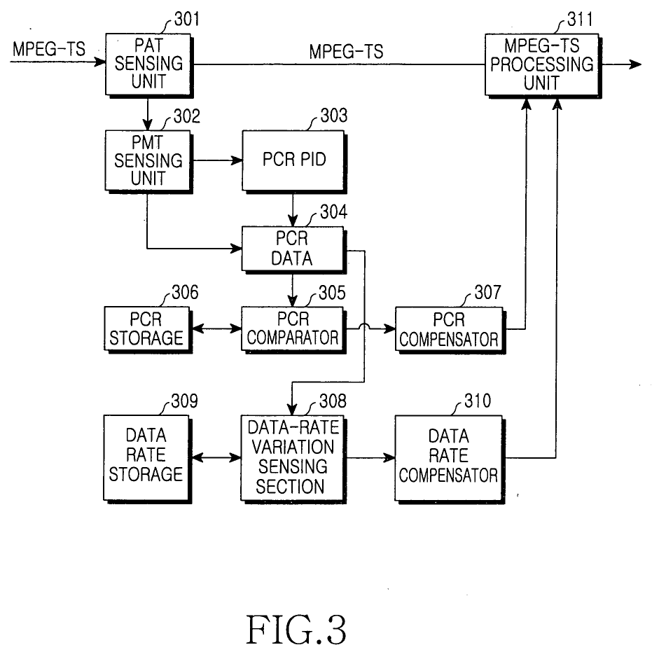

FIG. 3 is a block diagram illustrating the structure a PCR and data bit rate compensation apparatus provided in a reception device of an MPET-2 TS transmission system according to an embodiment of the present invention.

The PCR and data bit rate compensation apparatus provided in the reception device of the MPET-2 TS transmission system includes a PAT sensing unit 301, a PMT sensing unit 302, a PCR PID unit 303, a PCR data unit 304, PCR comparison/compensation unit 305, 306, and 307, data rate comparison/compensation unit 308, 309, and 310, and an MPEG-TS processing unit 311. The PAT sensing unit 301 senses a PAT from an MPET-2 TS. The PMT sensing unit 302 senses a PMT based on information provided from the PAT sensing unit 301. The PCR PID unit 303 senses a PCR PID based on information provided from the PMT sensing unit 302. The PCR data unit 304 outputs PCR data, based on the information provided from the PMT sensing unit 302 and the PID information provided from the PCR PID unit 303. The PCR comparison/compensation unit 305, 306, and 307 receives a PCR data from the PCR data unit 304, compares the received PCR with a pre-stored PCR, and compensates for the pre-stored PCR. The data rate comparison/compensation unit 308, 309, and 310 receives information about a data rate from the PCR data unit 304, compensates the received information with a pre-stored data rate, and compensates for the pre-stored data rate. The MPEG-TS processing unit 311 receives an MPET-2 TS, and converts the received MPET-2 TS into a broadcast signal, based on the PCR information and data rate information compensated by the PCR comparison/compensation unit 305, 306, and 307, and the data rate comparison/compensation unit 308, 309, and 310.

The PCR comparison/compensation unit 305, 306, and 307 includes a PCR storage 306, a PCR comparator 305 and a PCR compensator 307. The PCR storage 306 stores previous PCR information. The PCR comparator 305 receives PCR information from the PCR data unit 304, and compares the received PCR information with the previous PCR information stored in the PCR storage 306. In addition, when the received PCR information is different from the previous PCR information, the PCR comparator 305 stores the received PCR information at its current value in the PCR storage 306, and transmits the comparison result to the PCR compensator 307. The PCR compensator 307 receives comparison information based on a difference between the previous PCR information and the current PCR information from the PCR comparator 305, and transmits the comparison information to the MPEG-TS processing unit 311 to perform a compensating operation.

The data rate comparison/compensation unit 308, 309, and 310 includes a data rate storage 309, a data-rate variation sensing section 308 and a data rate compensator 310. The data rate storage 309 stores previous data rate information. The data-rate variation sensing section 308 receives data rate information from the PCR data unit 304, and compares the received data rate information with the previous data rate information stored in the data rate storage 309. In addition, when the received data rate information is different from the previous data rate information, the data-rate variation sensing section 308 stores the received data rate information at its current value in the data rate storage 309, and transmits the comparison result to the data rate compensator 310. The data rate compensator 310 receives comparison information based on a difference between the previous data rate information and the current data rate information from data-rate variation sensing section 308, and transmits the comparison information to the MPEG-TS processing unit 311 to perform a compensating operation.

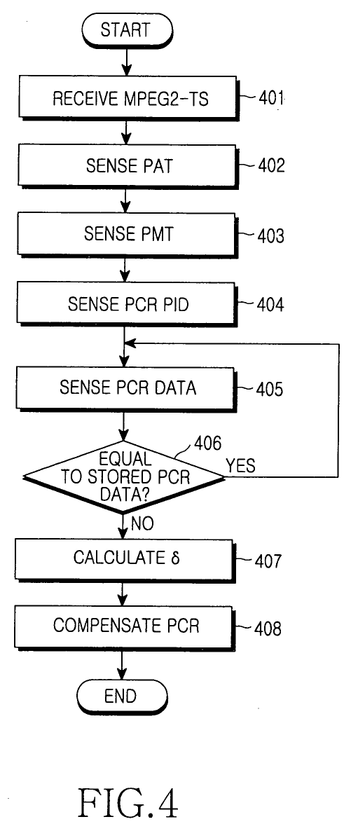

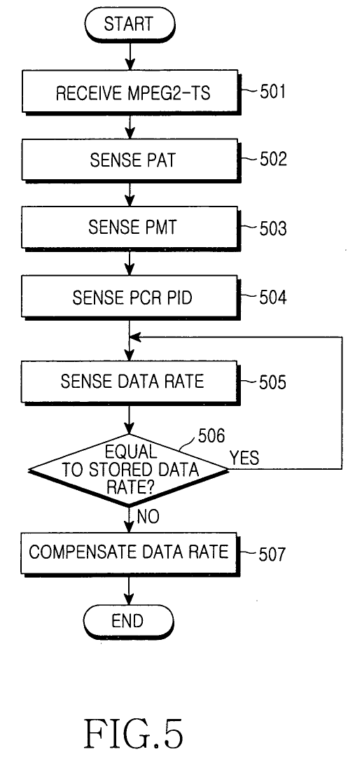

The procedure for compensating for a PCR or data bit rate using the PCR and data bit rate compensation apparatus provided in a reception device of an MPET-2 TS transmission system according to an embodiment of the present invention will now be described with reference to FIGS. 4 and 5.

FIG. 4 is a flowchart illustrating the procedure for compensating for PCR information in the PCR and data bit rate compensation apparatus provided in a reception device of an MPET-2 TS transmission system according to an embodiment of the present invention.

After reception of the MPET-2 TS in step 401, the PAT sensing unit 301 finds a PAT packet having a PID of “0x000” from among the received MPET-2 TS in step 402. In step 403, the PMT sensing unit 302 detects a PID of a PMT provided from the PAT sensing unit 301, and finds a corresponding PMT packet.

Then, the PCR PID unit 303 reads a PID value of a PCR provided in a payload of the PMT packet in step 404, and the PCR data unit 304 senses PCR data included in the payload of the PCR packet in step 405 and transmits the sensed PCR data to the PCR comparator 305.

The PCR comparator 305 compares the currently-received PCR information with previous PCR information pre-stored in the PCR storage 306 in step 406. When values of the compared information differ, the PCR comparator 305 newly stores the currently-received PCR information in the PCR storage 306. Based on a change in values compared in the PCR comparator 305, the value of “δ” is calculated in step 407 as shown in Equation 1.

$$δ = \frac{27 + 810 s [ PCR ( ⅈ ) - PCR ( {ⅈ}^{″} ) ]}{27 s {10}^{6}} + \frac{0.5 s 75 s {10}^{- 3} {s [ PCR ( ⅈ ) - PCR ( {ⅈ}^{″} ) ]}^{2}}{{( 27 s {10}^{6} )}^{2}} \\ Herein , \\ δ = 27 + 810 sxt + 0.5 s 75 s {10}^{3} {sxt}^{2} , and \\ xt = \frac{[ PCR ( ⅈ ) - PCR ( {ⅈ}^{″} ) ]}{27 s {10}^{6}} . \qquad ( 1 )$$

In contrast, when there is no change between the compared values, the PCR comparator 305 returns to step 405, to consecutively read new PCR information from the PCR data unit 304.

In step 408, the PCR compensator 307 receives the value of “δ” obtained through Equation 1, and compensates for an error of the PCR information.

Meanwhile, a data rate is compensated as follows.

FIG. 5 is a flowchart illustrating a procedure for compensating for a data rate in the PCR and data bit rate compensation apparatus provided in the reception device of an MPET-2 TS transmission system according to an embodiment of the present invention.

After reception of the MPET-2 TS in step 501, the PAT sensing unit 301 finds a PAT packet having a PID of “0x000” from among the received MPET-2 TS in step 502. In step 503, the PMT sensing unit 302 detects a PID of a PMT provided from the PAT sensing unit 301, and finds a corresponding PMT packet.

Then, the PCR PID unit 303 reads the value of a PCR PID provided in a payload of the PMT packet in step 504, and the PCR data unit 304 senses a data rate through a PCR data included in the payload of the PCR packet in step 505 and transmits the sensed data rate to the data-rate variation sensing section 308.

The data-rate variation sensing section 308 compares the currently-received data rate with a previous data rate pre-stored in the data rate storage 309 in step 506. When the compared data rates differ, the data-rate variation sensing section 308 newly stores the currently-received data rate in the data rate storage 309. In step 507, the data rate compensator 310 receives a changed data rate, and compensates for a data rate error.

Meanwhile, when there is no change in values compared in the data-rate variation sensing section 308, the data-rate variation sensing section 308 returns to step 505, to consecutively read new PCR information from the PCR data unit 304.

As described above, an algorithm is provided that can sense and compensate for an error in a PCR serving as a temporal reference in an MPET-2 TS. An apparatus and method are also provided that can sense and compensate for a variation of a data rate in the MPET-2 TS. Accordingly, when multimedia data are transmitted/received in the multimedia data transmission/reception system for inputting/outputting the MPET-2 TS, it is possible to minimize an error which may occur due to a rapid variation of a PCR and a data rate, thereby ensuring better QoS in the system.

The methods according to the present invention can be realized by a program and can be stored in a recording medium (such as a CD ROM, a RAM, a floppy disk, a hard disk, a magneto-optical disk, etc.) in a format that can be read by a computer.

While the present invention has been shown and described with reference to certain embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A reception apparatus for a moving picture experts group-2 transport stream (MPET-2 TS) transmission system, the device comprising:
a PAT sensing unit for sensing a PAT from a received MPET-2 TS;
a PMT sensing unit for sensing a PMT based on information provided from the PAT sensing unit;
a PCR PID unit for sensing a PCR PID based on information provided from the PMT sensing unit;
a PCR data unit for outputting PCR data based on information provided from the PMT sensing unit and PID information provided from the PCR PID unit;
a PCR comparison/compensation unit receiving the PCR data from the PCR data unit, comparing the received PCR data with a pre-stored PCR data, and compensating for the pre-stored PCR data; and
a data rate comparison/compensation unit for receiving data rate information from the PCR data unit, comparing the received data rate with a pre-stored data rate, and compensating for the pre-stored data rate.

2. The apparatus as claimed in claim 1, further comprising an MPEG TS processing unit that receives and converts the MPET-2 TS into a broadcast signal, by using the PCR information and the data rate information compared by the PCR comparison/compensation unit and the data rate comparison/compensation unit.

3. The apparatus as claimed in claim 1, wherein the PCR comparison/compensation unit comprises:
a PCR storage medium for storing a previous PCR data;
a PCR comparator for receiving the PCR data from the PCR data unit, comparing the received PCR data with the previous PCR data stored in the PCR storage medium, storing the received PCR data in the PCR storage medium when the received PCR data is different from the previous PCR data, and outputting a result of the comparison; and
a PCR compensator for receiving the comparison result, which has been output from the PCR comparator according to a difference between the previous PCR data and the PCR data received from the PCR data unit, to compensate for the previous PCR data based on the comparison result.

4. The apparatus as claimed in claim 2, wherein the PCR comparison/compensation unit comprises:
a PCR storage medium for storing a previous PCR data;
a PCR comparator for receiving the PCR data from the PCR data unit, comparing the received PCR data with the previous PCR data stored in the PCR storage medium, storing the received PCR data in the PCR storage medium when the received PCR data is different from the previous PCR data, and outputting a result of the comparison; and
a PCR compensator for receiving the comparison result, which has been output from the PCR comparator according to a difference between the previous PCR data and the PCR data received from the PCR data unit, to compensate for the previous PCR data based on the comparison result.

5. The apparatus as claimed in claim 3, wherein the PCR comparator obtains the comparison result corresponding to a difference between the previous PCR data and the PCR data received from the PCR data unit by using the following equation:
$$δ = \frac{27 + 810 s [ PCR ( ⅈ ) - PCR ( {ⅈ}^{″} ) ]}{27 s {10}^{6}} + \frac{0.5 s 75 s {10}^{- 3} {s [ PCR ( ⅈ ) - PCR ( {ⅈ}^{″} ) ]}^{2}}{{( 27 s {10}^{6} )}^{2}}$$
$$wherein , \\ δ = 27 + 810 sxt + 0.5 s 75 s {10}^{3} {sxt}^{2} , and$$
$$xt = \frac{[ PCR ( ⅈ ) - PCR ( {ⅈ}^{″} ) ]}{27 s {10}^{6}} .$$

6. The apparatus as claimed in claim 4, wherein the PCR comparator obtains the comparison result corresponding to a difference between the previous PCR data and the PCR data received from the PCR data unit by using the following equation:
$$δ = \frac{27 + 810 s [ PCR ( ⅈ ) - PCR ( {ⅈ}^{″} ) ]}{27 s {10}^{6}} + \frac{0.5 s 75 s {10}^{- 3} {s [ PCR ( ⅈ ) - PCR ( {ⅈ}^{″} ) ]}^{2}}{{( 27 s {10}^{6} )}^{2}}$$
$$wherein , \\ δ = 27 + 810 sxt + 0.5 s 75 s {10}^{3} {sxt}^{2} , and$$
$$xt = \frac{[ PCR ( ⅈ ) - PCR ( {ⅈ}^{″} ) ]}{27 s {10}^{6}} .$$

7. A method for a moving picture experts group-2 transport stream (MPET-2 TS) transmission system, the method comprising the steps of:
a) sensing a PAT from a received MPET-2 TS;
b) sensing a PMT by using sensed PAT information;
c) sensing a PCR PID by using sensed PMT information;
d) outputting a PCR data according to the sensed PMT information and PCR PID information; and
e) receiving and comparing the PCR data with a pre-stored PCR data, and compensating for the pre-stored PCR data based on a result of the comparison.

8. The method as claimed in claim 7, wherein step e) comprises the substeps of:
e-1) outputting a result of comparison between the PCR data and the pre-stored PCR data;
e-2) receiving and comparing the PCR data with the pre-stored PCR data, and storing the received PCR data instead of the pre-stored PCR data when the received PCR data is different from the pre-stored PCR data; and
e-3) receiving the output comparison result and compensating for the pre-stored PCR data based on the received comparison result.

9. The method as claimed in claim 8, wherein, in step e-1), the comparison result is obtained by using below equation:
$$δ = \frac{27 + 810 s [ PCR ( ⅈ ) - PCR ( {ⅈ}^{″} ) ]}{27 s {10}^{6}} + \frac{0.5 s 75 s {10}^{- 3} {s [ PCR ( ⅈ ) - PCR ( {ⅈ}^{″} ) ]}^{2}}{{( 27 s {10}^{6} )}^{2}}$$
$$wherein , \\ δ = 27 + 810 sxt + 0.5 s 75 s {10}^{3} {sxt}^{2} , and$$
$$xt = \frac{[ PCR ( ⅈ ) - PCR ( {ⅈ}^{″} ) ]}{27 s {10}^{6}} .$$

10. A method for a moving picture experts group-2 transport stream (MPET-2 TS) transmission system, the method comprising the steps of:
a) sensing a PAT from a received MPET-2 TS;
b) sensing a PMT by using sensed PAT information;
c) sensing a PCR PID by using sensed PMT information;
d) outputting a data rate according to the sensed PMT information and PCR PID information; and
e) receiving and comparing the data rate with a pre-stored data rate, and compensating for the pre-stored data rate based on a result of the comparison result.

11. The method as claimed in claim 10, wherein step e) comprises the steps of:
e-1) outputting a result of comparison between the data rate and the pre-stored data rate;
e-2) receiving and comparing the data rate with the pre-stored data rate, and storing the received data rate instead of the pre-stored data rate when the received data rate is different from the pre-stored data rate; and
e-3) receiving the output comparison result and compensating for the pre-stored data rate based on the received comparison result.

12. A reception apparatus for a moving picture experts group-2 transport stream (MPET-2 TS) transmission system, the device comprising:
a PCR PID detector arranged to detect PCR PID based on information from a received MPET-2 TS;
a comparator arranged to compare received PRC data from the PCR PID detector with a pre-stored PCR data; and
a compensation unit arranged to perform a compensation operation on the MPEG-2 TS based upon a result from the comparator.

13. The apparatus as claimed in claim 12, further comprising a data rate comparison/compensation unit for receiving data rate information, comparing the received data rate with a pre-stored data rate, and compensating for the pre-stored data rate.

14. The apparatus as claimed in claim 12, further comprising an MPEG TS processing unit that receives and converts the MPET-2 TS into a broadcast signal.

15. The apparatus as claimed in claim 14, wherein the comparator obtains the comparison result corresponding to a difference between the previous PCR data and the received PCR data received by using the following equation:
$$δ = \frac{27 + 810 s [ PCR ( ⅈ ) - PCR ( {ⅈ}^{″} ) ]}{27 s {10}^{6}} + \frac{0.5 s 75 s {10}^{- 3} {s [ PCR ( ⅈ ) - PCR ( {ⅈ}^{″} ) ]}^{2}}{{( 27 s {10}^{6} )}^{2}}$$
$$wherein , \\ δ = 27 + 810 sxt + 0.5 s 75 s {10}^{3} {sxt}^{2} , and$$
$$xt = \frac{[ PCR ( ⅈ ) - PCR ( {ⅈ}^{″} ) ]}{27 s {10}^{6}} .$$
